(19) United States
(12) Patent Application Publication
(10) Pub. No.: US 2026/0334724 A1
(43) Pub. Date: Oct. 29, 2026

(54) APPARATUS AND RELATIVE KIT FOR COOKING FOODSTUFFS

(71) Applicant: DE' LONGHI APPLIANCES S.R.L. CON UNICO SOCIO, Treviso (IT)

(72) Inventors: Renzo Mazzon, Treviso (IT); Alessandro Tome, Treviso (IT); Massimo Steiner, Treviso (IT)

(73) Assignee: DE' LONGHI APPLIANCES S.R.L. CON UNICO SOCIO, Treviso (IT)

(21) Appl. No.: 19/118,943

(22) PCT Filed: Oct. 4, 2023
(86) PCT No.: PCT/IT2023/050220

§ 371 Date: Apr. 7, 2025

(30) Foreign Application Priority Data
Oct. 7, 2022 (IT) 102022000020730

(51) Int. Cl. A47J 37/06; A47J 36/16; A47J 36/32; F24C 15/32

(52) U.S. Cl. CPC A47J 37/0641; A47J 36/16; A47J 36/32; F24C 15/325

(57) ABSTRACT

Apparatus (10) for cooking foodstuffs comprising a support body (11), a container (13) able to be removed/inserted with respect to said support body (11), at least one heating device (14) and a ventilation device (15) disposed inside said support body (11).

### FIELD OF APPLICATION

The present invention refers to an apparatus for cooking foodstuffs by hot air having a support body and a container, such as a bowl or drawer, insertable and extractable from the support body and inside which the foodstuffs to be cooked are placed. In particular, the container according to the invention allows an insertion, but above all a simple extraction of the foodstuffs especially after they have been cooked.

### BACKGROUND ART

Autonomous cooking apparatuses such as compact ovens, “multicookers”, or “air fryers”, perform a cooking of foodstuffs by means of a heated air flow and generally comprise a support body and a container for foodstuffs which, by means of a handle, can be inserted and removed with respect to the support body along a lateral or vertical direction.

Generally, the container is formed, in a single body, by a bottom wall, having a contact surface where the foodstuffs are placed, and by side containing walls having a height that allows the container to have a capacity for a certain amount of foodstuffs without them being able to escape.

One of the drawbacks of the current containers is that the height of the containing walls makes it difficult to extract all those foodstuffs that require a removal from the mould, for example bakery products such as pizza, bread, cakes, tarts, etc. In addition, in the case of bakery products, in particular those that increase in volume during baking, there is a risk that these adhere to the containing or bottom walls, preventing a “neat” extraction without damage to their shape.

A further drawback of the current containers is that the contact surface of the bottom wall does not have a conformation that allows optimal cooking of all foodstuffs. In fact, some foodstuffs may require a flat contact surface, others a corrugated one, others even a moulded one.

A further drawback of the current containers is related to their washing which is particularly difficult since some areas, such as those adjacent to the bottom wall, are difficult to reach for optimal cleaning.

Documents US2021/219778A1 and CN208481145U describe known cooking apparatuses comprising a drawer-like container which can be inserted and removed from a housing compartment and defines a cooking chamber, and an accessory for containing the foodstuffs which can be positioned inside the removable container, wherein the accessory is provided with a removable bottom wall. In these known apparatuses, the accessory with removable bottom and the cooking chamber are two distinct and separate components, that is, the accessory is inserted inside the cooking chamber which, in turn, can be inserted/removed with respect to the apparatus' support body.

US2009/134140A1 describes an apparatus for preparing foodstuffs comprising a double-walled cooking chamber, wherein the internal wall comprises an air permeable portion.

Document DE2756968A1 describes an oven, complete with a door, into which a container for foodstuffs can be inserted.

Documents DE202006018199U1, DE202005005757U1 and DE9010519U1 describe containers for foodstuffs with removable bottoms, normally known by the term “cake baking trays”, which are not part of a cooking apparatus but are simply an accessory that can be used in certain circumstances. There is therefore no functional and structural integration with the components of the cooking apparatus.

There is therefore a need to improve an apparatus for cooking foodstuffs that can overcome at least one of the drawbacks of the prior art.

One object of the present invention, which corresponds to the technical problem to be solved, is to provide a cooking apparatus comprising a container that allows a simple and rapid extraction of any foodstuff, preserving the shape and the consistency thereof.

Another object of the present invention is to realise a cooking apparatus that allows an optimal cooking of any type of foodstuff.

Another object of the present invention is to realise a cooking apparatus having a container that is structurally simple, convenient to use, and easily washable.

Another object of the present invention is to realise a cooking apparatus that allows to clean the bottom and the adjacent areas of the container which defines the apparatus' cooking chamber in an optimal manner.

A further object of the invention is to realise a cooking apparatus that is versatile and in which the configuration of the container which defines the cooking chamber can be quickly modified and adapted according to needs.

The Applicant has studied, tested and realized the present invention to overcome the drawbacks of the prior art, and to obtain the above as well as further objects and benefits.

### DISCLOSURE OF THE INVENTION

The present invention is expressed and characterized in the independent claims. The dependent claims show other features of the present invention or variants of the main solution proposed.

In accordance with the aforementioned objects and in order to solve the aforementioned technical problem in a new and original way, also obtaining considerable advantages with respect to the prior art, an autonomous apparatus for cooking foodstuffs according to the present invention comprises a support body, a container able to be extracted/inserted with respect to said support body, at least one heating device and a ventilation device disposed inside said support body.

In accordance with an aspect of the present invention, said container comprises a removable bottom wall.

In this way, after cooking and after the container has been extracted from the support body of the apparatus, it is possible to release the bottom wall on which the foodstuffs rest, facilitating their extraction without damaging or ruining them. The components of the container are also preserved because the removal of foodstuffs does not require the use of kitchen utensils such as knives, spatulas and the like that could damage the lining or the structure of the container.

In accordance with another aspect of the present invention, said container is a single component configured both to define a space for containing said foodstuffs to be cooked and also to define a cooking chamber for cooking said foodstuffs.

The container is provided with respective solid containing bottom walls, that is, without holes or apertures, which are suitable to delimit a containing volume for the foodstuffs, preventing possible leakage of the foodstuffs or any cooking liquids outside the container.

The possibility of removing the bottom of the container that defines the cooking chamber allows to clean both the bottom wall and also the adjacent areas in an optimal manner, in particular the areas of connection with the lateral walls, and, moreover, makes it possible to directly modify the conformation of the cooking chamber without having to provide accessories to be inserted inside it.

In accordance with another aspect of the present invention, said container comprises an annular perimeter containing wall, able to selectively divaricate to allow a removal of said bottom wall.

Advantageously and in a simple way, the removal of the bottom wall is allowed by acting on the containing wall. This also allows a first detachment of the foodstuffs in case they were attached to the containing wall.

In accordance with another aspect of the present invention, said containing wall and said bottom wall directly delimit said cooking chamber.

In accordance with another aspect of the present invention, said containing wall is integrally formed by a plurality of wall elements, wherein a head wall element cooperates sliding with a tail wall element. This configuration of the containing wall allows a slight opening/closing thereof while maintaining its shape, but allowing the bottom wall to be released, if necessary.

According to possible variants, it can also be provided that the end edges of the respective head and tail wall elements in the closed condition are in contact with each other, or partly overlapping, and in the open position are spaced apart from each other.

In accordance with another aspect of the present invention, said container is provided with coupling elements having a reciprocally mating shape, wherein said bottom wall has its own upper perimeter edge which forms a first coupling element and said containing wall has its own lower perimeter edge which forms a second coupling element. The coupling elements can determine a mechanical shape, snap coupling, or the like.

According to a particularly advantageous solution, the coupling elements determine a liquid-tight coupling.

In accordance with another aspect of the present invention, said container comprises drive means formed by a fixed support and a mechanism which is associated both with said support and also with said containing wall.

Said drive means advantageously also comprise an actuator which can be driven by a user and is configured to allow the activation of the drive means and the mechanism.

According to embodiments, the container comprises a handle which can be gripped by a user to insert and remove the container from the support body.

According to embodiments, the actuator for removing the bottom wall can be positioned on the handle or on a support which is able to act as the front wall of the container and, during use, of the support body.

According to embodiments, the mechanism comprises attachment elements attached to said wall elements respectively and a movement device associated both with said attachment elements and also with said actuator operable by a user.

The drive means allow a user to release the bottom wall from the containing wall in a very simple and effortless way by acting on the actuator.

The actuator is preferably of the manual type and may be realized as a rotational element, a translational element, a trigger, or the like.

In accordance with another aspect of the present invention, said attachment elements are mounted cantilevered through said support and they are sliding, reciprocally toward/away from each other, in respective slots made through in said support. This makes it possible to determine an “open” position and a corresponding “closed” position of the respective head and tail wall elements and therefore of the containing wall.

In accordance with another aspect of the present invention, said movement device comprises an articulated parallelogram, formed by two first rods, which are provided with dragging elements, and two second rods, said first and second rods being pivoted both to each other and to said attachment elements, and a cam rotatably mounted on said support and provided with two shaped profiles in which said dragging elements are engaged.

In accordance with another aspect of the present invention, said movement device comprises a rocker arm pivoted to said support, and two connection rods associated both with corresponding opposite end portions of said rocker arm and also with a respective one of said attachment elements.

In accordance with an embodiment, said movement device comprises a pinion pivoted to said support, and two racks, which are engaged with said pinion and attached to a respective one of said attachment elements.

In accordance with another aspect of the present invention, said apparatus comprises a clamping device operatively connected to said drive means and/or to said actuator when said container is disposed inside said housing compartment.

This allows to prevent an inadvertent removal of the bottom wall from occurring automatically.

In accordance with another aspect of the present invention, said apparatus comprises a control unit and detection means, for example a sensor, which are operatively connected to said control unit and configured to detect a recognition element, for example a bar code, a QR code, an RFID code, or an electromechanical element (microswitch, reed switch, etc.) associated with said bottom wall and to send the detected information to said control unit. For example, such information may relate to the shape, the material, the thickness, or the conformation of the contact surface of the bottom wall.

Embodiments of the present invention refer to a kit for cooking foodstuffs comprising an apparatus as defined above, and a plurality of additional bottom walls, each having a specific surface conformation suitable for different cooking or foodstuffs to be cooked.

Thanks to the removal of the bottom wall and the provision of a plurality of different bottom walls, able to be selectively and alternatively connected to the containing wall, it is possible to modify the characteristics of the container in a simple and quick way and then adapt the cooking apparatus on each occasion to make it suitable for cooking a certain type of foodstuffs.

Since it is sufficient to replace the bottom walls to modify the characteristics of the cooking apparatus without the need to provide for a plurality of different containers, each provided with a given type of bottom wall, it is also possible to minimize the footprint of the kit.

In accordance with another aspect of the present invention, said control unit, on the basis of the detected information, is configured to suggest a cooking mode which can be preferably executed in the container that has the bottom wall detected by said detection means. This allows to “guide” even less experienced users and always ensure optimal results in cooking foodstuffs.

### ILLUSTRATION OF THE DRAWINGS

These and other aspects, features and advantages of the present invention will become clear from the following disclosure of some embodiments, provided merely by way of non-limiting example only, with reference to the accompanying drawings in which:

FIG. 1 is a schematic sectional side view of an apparatus for cooking foodstuffs according to the present invention;

FIG. 1a is an enlarged view of a detail of FIG. 1;

FIG. 1b is an enlarged view of a detail of FIG. 1 according to a variant embodiment;

FIG. 2 is an embodiment variant of the apparatus of FIG. 1;

FIG. 3 is a schematic sectional view of the drive means;

FIGS. 4-5 are axonometric views of an embodiment of the container of FIG. 1 and 2;

FIGS. 6-7 are axonometric views of a further embodiment of the container of FIGS. 1 and 2;

FIGS. 8-9 are axonometric views of a further embodiment of the container of FIGS. 1 and 2;

FIG. 10 is a schematic view of a kit for cooking foodstuffs according to the present invention.

It should be noted that, in the present disclosure, the phraseology and terminology used, as well as the figures in the accompanying drawings, even as disclosed, have the sole purpose of illustrating and explaining the present invention, since their function is illustrative and not limited to the invention itself, the scope of protection thereof being defined by the claims.

To facilitate understanding, identical reference numbers have been used, where possible, to identify identical common elements in the figures. It should be noted that elements and features of an embodiment can be conveniently combined or incorporated into other embodiments without further clarification.

### DESCRIPTION OF CERTAIN EMBODIMENTS OF THE PRESENT INVENTION

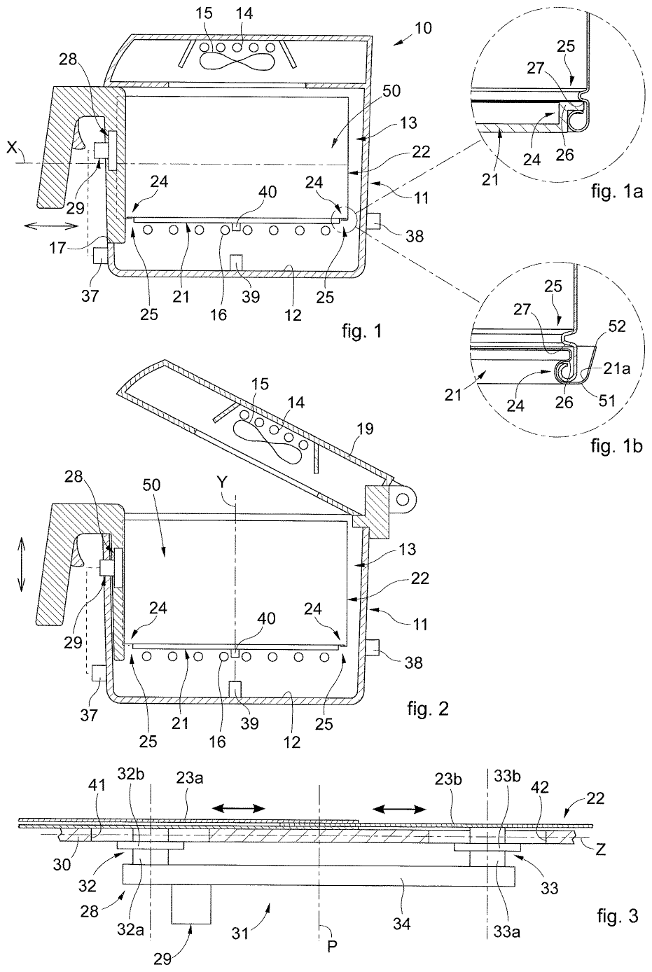

With reference to FIGS. 1 and 2, an autonomous cooking apparatus 10 according to the present invention comprises a support body 11, which constitutes an outer casing, having a housing compartment 12, an inner container 13 able to be extracted/inserted with respect to the housing compartment 12, at least one heating device 14 and a ventilation device 15 disposed inside the support body 11.

By the term “autonomous” we mean an apparatus capable of cooking foodstuffs without the direct supervision of a user, or in any case without substantially requiring manual intervention during the cooking phase, such as an electric pan, also called “multi-cooker”, or an air fryer for example.

The container 13 is open at the top and, depending on the type it can have a capacity between 1 and 5 litres.

The cooking apparatus 10 is suitable for cooking a plurality of foodstuffs of different type. The foodstuffs we are discussing about can be potatoes, vegetables, but not only, also rice, cereals in general, pasta, couscous, meat, fish, whether fresh or frozen.

As will be evident in the following description, the container 13 of the present invention is also particularly advantageous for baking baked goods, for example, pizza, bread, cakes, tarts, lasagna, etc., which tend to adhere to the walls of the container 13, thereby preventing their extraction, immediately after baking, without damage to the shape, or are difficult to be extracted.

According to the present invention, the container 13 is a single component which acts both as a containing chamber and also as a cooking chamber for the foodstuffs.

Furthermore, this apparatus 10 is able to perform different cooking modes, for example stewing, braising, roasting, frying, simple warming up, sizzling, browning, slow cooking, or rapid cooking in general or possibly also steam cooking if a certain amount of water is suitably introduced into the container 13 together with the foodstuffs.

The at least one heating device 14, also called the upper heating device, is preferably disposed, together with the ventilation device 15, in an upper portion of the support body 11, i.e. it is placed, in use, above the container 13.

Preferably, the apparatus 10 also comprises an additional heating device 16, also called a lower heating device, disposed in a lower portion of the support body 11, i.e. it is placed, in use, below the container 13.

Optionally, the apparatus may comprise additional ventilation devices, not illustrated.

The lower heating device 16 can be commanded independently of the upper heating device 14 so that it is possible to activate one, the other or both depending on the needs and the cooking mode to be performed.

The upper 14 and/or lower 16 heating device may be, for example, electrical resistors, connected to respective power supply devices, not illustrated, able to be selectively commanded in order to turn them on and off so as to adjust their temperature and consequently the temperature inside the housing compartment 12 and the container 13.

The ventilation device 15 may be, for example, an impeller provided with a plurality of blades driven by a motor member.

According to the embodiment of FIG. 1, the support body 11 can be opened laterally by means of the same container 13 which, substantially, externally completes the support body 11 causing a closure of the housing compartment 12.

The support body 11 has a lateral passage opening 17 suitable for allowing access to the housing compartment 12 for the insertion and extraction of the container 13, which in this case is of the “drawer” type, along a horizontal direction X.

According to the embodiment of FIG. 2, the support body 11 can be opened on the top by means of a cover 19.

In this case, the support body 11 may comprise a baseplate 18, in which the housing compartment 12 and the lower heating device 16 are present, and the cover 19 can be selectively associated with the baseplate 18 to allow or prevent access to the housing compartment 12 from above.

The baseplate 18 and the cover 19 are distinct components from each other and the cover 19 may be, for example, hinged to the baseplate 18. The container 13 is able to be extracted/inserted with respect to the housing compartment 12 along a vertical direction Y.

According to the embodiment of FIG. 2, the upper heating device 14 and the ventilation device 15 can be housed inside the cover 19.

The container 13 comprises a bottom wall 21 and a perimeter containing wall 22 having an annular shape mating with the shape of the bottom wall 21.

The bottom wall 21 and the containing wall 22 delimit the containing and cooking chamber, the latter two coinciding.

The bottom wall 21 and the containing wall 22 are solid, that is, they are without holes or apertures.

According to one aspect of the invention, the bottom wall 21 is removable with respect to the containing wall 22, i.e. the bottom wall 21 can be selectively separated from the containing wall 22 to facilitate the extraction of previously cooked foodstuff.

In other words, the bottom wall 21 and the containing wall 22 are two distinct components, which are selectively associable and separable from one another.

The container 13 has an assembled condition in which the bottom wall 21 and the containing wall 22 are temporarily integral, and a disassembled condition in which the bottom wall 21 can be removed from the containing wall 22.

The removal of the bottom wall 21 allows to clean the bottom wall of the cooking chamber 50 of the apparatus 10 effectively.

The containing wall 22 can be slightly divaricated to allow the removal of the bottom wall 21. In other words, the containing wall 22 may be slightly widened and correspondingly closed for the disengagement and engagement of the bottom wall 21, respectively. Operationally, the disengagement of the bottom wall 21 with respect to the containing wall 22 may occur when the container 13 is outside the housing compartment 12.

The containing wall 22, when slightly divaricated, substantially keeps its annular shape. In other words, the containing wall 22 always keeps a closed-loop geometry.

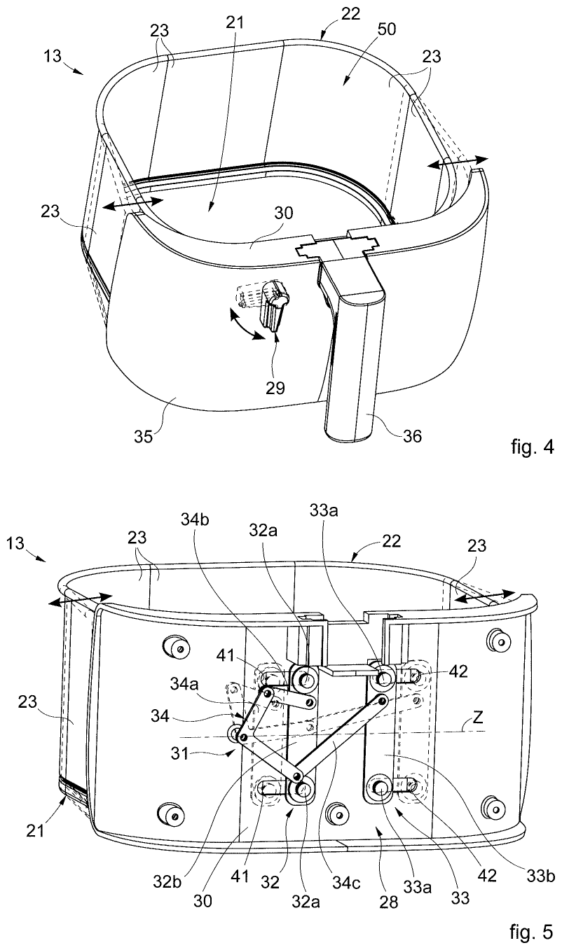

With reference to FIGS. 3-7, the containing wall 22 may be integrally formed by a plurality of wall elements 23 firmly connected to each other (FIGS. 4-7), for example two or more.

The plurality of wall elements 23 comprise at least one head wall element 23a and at least one tail wall element 23b, which reciprocally cooperate at least to define the assembled condition.

According to embodiments, the head wall element 23a cooperates sliding with the tail wall element 23b to allow a slight divarication of the containing wall 22 (FIG. 3).

In the example of FIG. 3, a flap of the tail wall element 23b is slidingly inserted into a flap of the head wall element 23a.

According to one embodiment, said flaps can be slidingly paired.

The container 13 is provided with coupling elements 24, 25 configured to cooperate with each other to keep the container 13 in the assembled condition.

The coupling elements 24, 25 have a reciprocally mating shape and comprise a first coupling element 24 disposed on, or being part of, the bottom wall 21 and a second coupling element 25 disposed on, or being part of, the containing wall 22.

With reference to FIG. 1a, the bottom wall 21 has its own upper perimeter edge which forms the first coupling element 24 and the containing wall has its own lower perimeter edge which forms the second coupling element 25. The first coupling element 24 may be or comprise an edge or a protrusion 26 and the second coupling element 25 may be or comprise a groove 27 having a shape mating with the shape of the edge or of the protrusion 26. It is clear that additional types of temporary joint couplings are still possible.

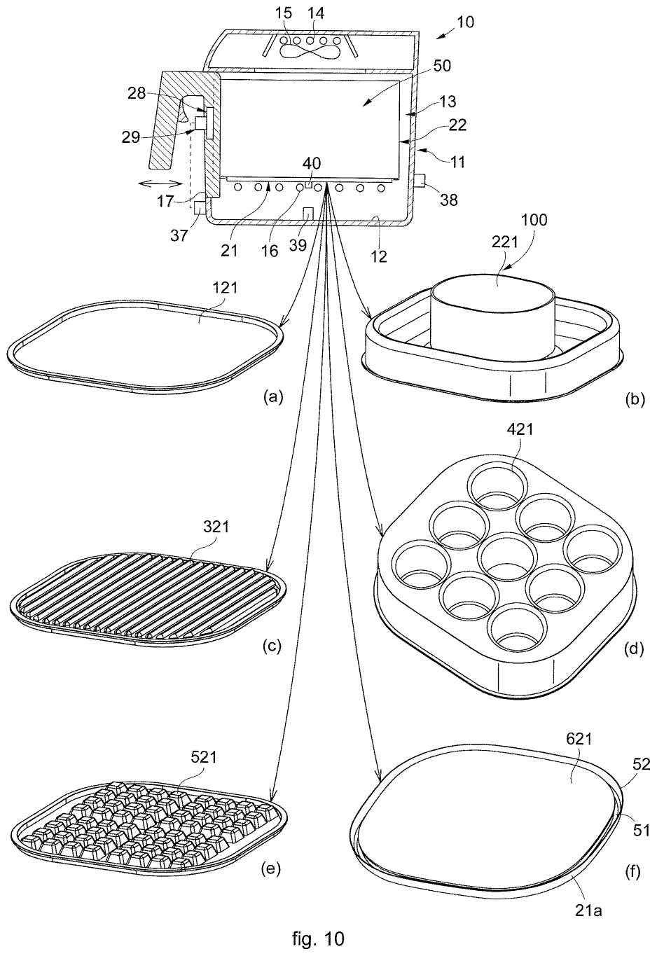

With reference to the variant of FIG. 1b, the bottom wall 21 also comprises a perimeter dripper 21a, consisting of a lowered part 51 and a raised edge 52 which together define a zone for collecting a liquid, see also FIG. 10(f) below.

The coupling elements 24, 25 may determine a liquid-tight coupling. This is particularly advantageous if the foodstuffs to be cooked have a predominantly liquid phase.

The bottom wall 21 can have any perimeter shape (see FIG. 10), but always has said first coupling elements 24.

The bottom wall 21, which in the present case has a rectangular shape with rounded corners, can alternatively be configured with a generally quadrangular, circular, elliptical shape. In addition, the bottom wall 21 may be substantially flat, conical, humpbacked, or generally have discontinuities and depressions.

The containing wall 22 has a perimeter shape mating with the shape of the bottom wall 21, but always has said second coupling elements 25.

The containing wall 22, which in the present case has a continuous inner surface, may optionally have discontinuities, for example protrusions or depressions.

The bottom wall 21 can be made of the same material, or of a different material, than that of the containing wall 22.

The bottom wall 21 can be made with the same thickness, or with a different thickness, than that of the containing wall 22.

For example, the containing wall 22 may be made of steel to ensure good structural stability with low thicknesses, and the bottom wall 21 may be made of aluminium with the desired thickness so as to ensure good thermal conductivity and thus effective cooking of the foodstuffs.

Optionally, the coupling elements 24, 25 can be made of, or coated with, materials different from those of which the bottom wall 21 and the containing wall 22 respectively are formed.

For example, the coupling elements 24, 25 can be made of or coated with a polymeric material that allows increasing the mutual adhesion between the walls 21, 22 and the hermetic effect of the coupling made between them.

The container 13 comprises drive means 28 associated with the containing wall 22 to allow the opening/closing thereof with consequent engagement/disengagement of the bottom wall 21, and an actuator 29 to allow the activation of the drive means 28.

According to embodiments, the actuator 29 can be positioned on a handle 36 of the container 13, or on a support which is disposed in correspondence with a front wall of the container 13 where the handle 36 is provided.

With reference to FIGS. 1-7, the drive means 28 comprise a fixed support 30 and a mechanism 31 associated both with the support 30 and also with the containing wall 22.

The support 30 can itself define a front wall of the container 13 or be connected to such front wall.

During use, that is, when the container 13 is inserted in the support body 11, the support 30 can also act as the front wall of the support body 11 in order to close the housing compartment 12 and isolate its internal environment from the external one.

The support 30 can be conformed in such a way as to wrap the containing wall 22 at least frontally, that is, at least for the part defining the front wall.

Advantageously, the support 30 can have a curved conformation, for example in the shape of a “U” or “C”, in such a way as to partly wrap the containing wall 22 also laterally, while remaining at a certain distance from the latter, allowing it to be divaricated.

The mechanism 31 is configured to allow a movement of the containing wall 22, or at least of the respective head and/or tail elements 23a, 23b, with respect to the fixed support 30.

With particular reference to FIG. 3, the mechanism 31 comprises first and second attachment elements 32, 33 respectively attached to the head wall element 23a and to the tail wall element 23b, in respective symmetrical positions with respect to a central plane P. The central plane P is a vertical plane.

The attachment elements 32, 33 are mounted cantilevered through the support 30 and they are sliding, reciprocally toward/away from each other, in respective slots 41, 42 made through in the support 30.

The slots 41, 42 act as guides for the attachment elements 32, 33 and have an extension, parallel to a movement axis Z, which is substantially horizontal and orthogonal to the central plane P, such as to define an opening end stroke and an opposite closing end stroke which correspond to the opening and closing of the containing wall 22.

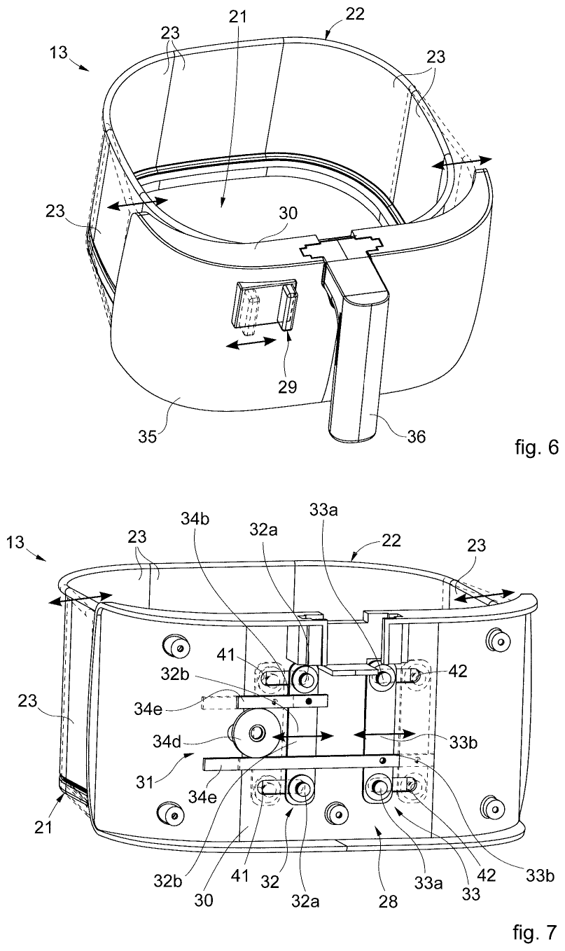

In the examples of FIGS. 5 and 6, the first and second attachment elements 32, 33 each respectively comprise two vertically spaced pins 32a, 33a and a connection plate 32b, 33b which connects the respective pins 32a, 33a. The pins 32a, 33a are attached to the containing wall 22 and pass through the slots 41, 42.

The mechanism 31 comprises a movement device 34 associated both with the attachment elements 32, 33 and also with the actuator 29.

According to the embodiment of FIGS. 4-5, the movement device 34 comprises a rocker arm 34a pivoted, with respect to an intermediate portion thereof, to the support 30, and two connection rods 34b, 34c associated respectively with the rocker arm 34a and with one of the attachment elements 32, 33. In particular, the connection rods 34b, 34c are connected through respective rotary couplings both to corresponding opposite end portions of the rocker arm 34a and also to a respective one of the attachment elements 32, 33.

According to this embodiment, the actuator 29 can be associated with the rocker arm 34a to allow, by its rotation, the divarication of the head 23a and tail 23b wall elements and therefore the opening of the containing wall 22.

According to the embodiment of FIG. 6-7, the movement device 34 comprises a pinion 34d pivoted to the support 30 and two racks 34e, engaged with the pinion 34d, of which a first is attached to the first attachment elements 32 and a second is attached to the second attachment elements 33.

The actuator 29 may be associated with the pinion 34d to allow, by its rotation, the divarication of the containing wall 22.

The actuator 29 may also be associated with one of the two racks 34e and thus be driven with a corresponding horizontal translation movement in the direction of the movement axis Z.

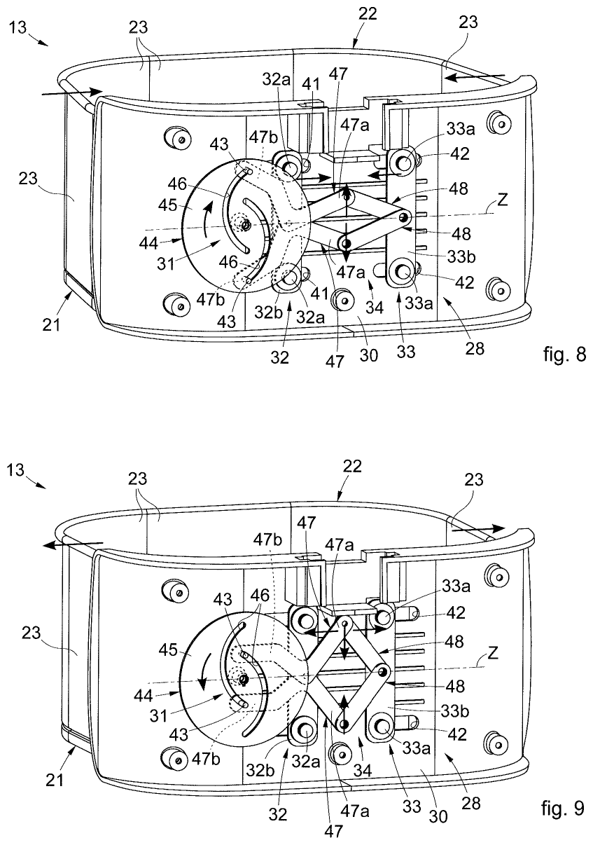

According to the embodiment of FIGS. 8 and 9, the movement device 34 is of the “pantograph” type with “cam” type motion transmission.

The movement device 34 comprises an articulated parallelogram formed by two first rods 47 and two second rods 48 which are pivoted together at the first ends of the first and second rods 47 and 48.

The first rods 47 are further pivoted both to each other and also with the connection plate 32b of the first attachment elements 33 at an intermediate point of the latter. The point where the pivoting takes place corresponds to an intermediate zone of the first rods 47 that is located between their respective ends.

Similarly, the second rods 48 are further pivoted both to each other and also to the connection plate 33b of the second attachment elements 33 at an intermediate point thereof. The point where the pivoting takes place is located at a second end of the second rods 47.

Each of the first rods 47 has a pivot section 47a and an actuation section 47b which is angled, approximately by about 90°, with respect to the pivot section 47 a and having an elbow that determines two parts inclined to each other, approximately at an angle of about 135°. The pivot sections 47 a have the same length as the second rods 48.

The actuation sections 47b are provided with dragging elements 43. The dragging elements 43 are disposed at a second end of the first rods 47. In the example of FIGS. 8 and 9 the dragging elements 43 are cylindrical shaped pins.

The movement device 34 further comprises a cam 44, for example having a disc shape, rotatably mounted on the support 30 and provided with two shaped profiles 46 in which the dragging elements 43 are engaged.

The two shaped profiles 46 form an arcuate path that, during the rotation of the cam, acts as a guide for the dragging elements 43 which cause a consequent rotation of the first rods 47. The cam 44 is connected to the actuator 29 which can be rotated clockwise to cause the closure of the containing wall 22 (FIG. 8) or counterclockwise to cause the opening thereof (FIG. 9).

The mechanism 34 of FIGS. 8 and 9 allows the coupling with the first and second attachment elements 32, 33 on a median plane that turns out to be a particularly effective position to facilitate the dynamics of the opening/closing movement of the containing wall 22.

According to embodiments, the actuator 29 is of the manual type and can be a rotational element (FIG. 4), a translational element (FIG. 6), a trigger (FIGS. 1 and 2) or the like.

A front mask 35 can be attached to the support 30 which, together with the support 30, defines a technical compartment where the drive means 28 are present.

According to possible embodiments, the actuator 29 can be associated with, or disposed passing through, the front mask 35.

The container 13 may further comprise a grip, or handle 36 attached to the support 30, preferably in a central position suitable to facilitate the operation of extracting the container 13 from the support body 11.

This handle 36 can be attached to the support 30 by screwing, or rivets, or snap tightening.

The actuator 29 may be positioned on the front mask 35 or may be positioned on the grip 36.

With reference to FIGS. 1-2, the apparatus 10 comprises a clamping device 37 operatively connected to the drive means 28 and/or to the actuator 29 when the container 13 is disposed inside the housing compartment 12 and configured to prevent the activation of the drive means 28 and therefore the opening of the containing wall 22.

The apparatus 10 further comprises a control unit 38 configured to regulate the operation of at least the heating devices 14, 16 and of the ventilation device 15 depending on a cooking mode set by a user. The control unit 38 may also be operatively connected to the clamping device 37.

Optionally, the apparatus 10 may comprise detection means 39 and the container 13, in particular the bottom wall 21, may be provided with a recognition element 40, which may contain information relating to the shape of a contact surface of the bottom wall 21 (i.e. the one on which the foodstuffs are placed), the thickness, or the type of material, and is detectable, or readable, by said detection means 39.

The control unit 38 can also be operatively connected to the detection means 39 to suggest to the user the preferred cooking modes with that type of bottom wall 21, which can be possibly modified through a user interface based on the exact type of food and its quantity.

With reference to FIG. 10, a kit for cooking foodstuffs 100 comprises the apparatus 10 previously described, wherein the bottom wall 21 of the container 13 is replaceable/interchangeable, and at least one additional bottom wall 121, 221, 321, 421, 521, 621 distinct from the bottom wall 21.

The kit 100 may preferably comprise a plurality of bottom walls 121-621 each having a specific surface conformation suitable for different cooking or different foodstuffs to be cooked.

For example, the bottom wall 121 of FIG. 10(a) has a flat contact surface and may be suitable for cooking foodstuffs such as lasagna, cakes, pizzas, etc.

The bottom wall 221 of FIG. 10(b) has a toroidal cavity and may be suitable for baking a bundt cake.

The bottom wall 321 of FIG. 10(c) has a lamellar conformation and is suitable for use as a grid.

The bottom wall 421 of FIG. 10(d) has a plurality of seats suitable for baking muffins.

The bottom wall 521 of FIG. 10(e) has a “honeycomb” structure and is suitable for baking waffles.

The bottom wall 621 of FIG. 10(f) has a flat contact surface with a perimeter dripper, consisting of a lowered zone for collecting a liquid, and may be suitable for cooking foodstuffs having a liquid phase.

In the operational configuration illustrated in FIG. 10, when the detection means 39 detect the presence of one of the bottom walls 21-621, the control unit 38 can select the cooking mode and regulate the operation of the various components accordingly.

For example, the cooking mode suggested using one of the bottom walls 21, 121, 221, 421, 521, 621 can be air frying, or baking dishes such as pizza, savoury cakes, lasagna, etc., and provides for the simultaneous operation of the upper 14 and the lower 16 heating device, to reach a temperature ranging from 150 to 250 °C, and of the ventilation device 15 placed at the top for it to generate an average speed air flow downstream of the blades of 2-4 m/s.

The cooking mode suggested using the bottom wall 321 provides for a first heating step in which the upper 14 and lower 16 heating devices are both in operation and the ventilation device 15 generates an average speed air flow of about 2 m/s downstream of the blades. As soon as the temperature of 250 °C is reached, it follows a second heating step in which only the lower heating device 16 operates in order to keep the temperature constant until the end of cooking.

It is clear that modifications and/or additions of parts can be made to the apparatus 10 and to the kit 100 for cooking foodstuffs described above, without thereby leaving the scope of the present invention as defined by the claims.

It is also clear that, although the present invention has been described with reference to some specific examples, a person skilled in the art will be able to make many other equivalent forms of apparatus and relative kit for cooking foodstuffs having the features expressed in the claims and therefore all of which falling within the scope of protection defined thereby.

In the claims which follow, the references in brackets have the sole purpose of ease of reading and should not be considered as limiting factors of the scope of protection defined by the claims themselves.

1. An apparatus for cooking foodstuffs comprising a support body, at least one heating device and a ventilation device, both disposed inside said support body and a container able to be extracted/inserted with respect to said support body, wherein said container comprises a removable bottom wall.

2. The apparatus of claim 1, wherein said container is a single component configured both to contain said foodstuffs and also to define a cooking chamber for cooking said foodstuffs.

3. The apparatus of claim 1, wherein said container comprises an annular perimeter containing wall able to selectively divaricate to allow a removal of said bottom wall.

4. The apparatus of claim 3, wherein said containing wall is formed by a plurality of wall elements wherein a head wall element cooperates sliding with a tail wall element.

5. The apparatus of claim 3, wherein said container is provided with coupling elements that have a reciprocally mating shape, wherein said bottom wall has its own upper perimeter edge which forms a first coupling element and said containing wall has its own lower perimeter edge which forms a second coupling element.

6. The apparatus of claim from 3, wherein said container comprises drive means formed by a fixed support and a mechanism, which is associated both with said support and also with said containing wall, and an actuator to allow the activation of said drive means.

7. The apparatus of claim 6, wherein said actuator is positioned on a handle (36) of said container or on said support.

8. The apparatus of claim 4, wherein said mechanism comprises attachment elements attached to said head and tail wall elements respectively, and a movement device associated both with said attachment elements and also with said actuator.

9. The apparatus of claim 8, wherein said attachment elements are mounted cantilevered through said support and they are sliding, reciprocally toward/away from each other, in respective slots made through in said support.

10. The apparatus of claim 8, wherein said movement device comprises an articulated parallelogram, formed by two first rods, which are provided with dragging elements and two second rods, which are pivoted to each other and to said attachment elements and a cam rotatably mounted on said support and provided with two shaped profiles in which said dragging elements are engaged.

11. The apparatus of claim 8, wherein said movement device comprises a rocker arm pivoted to said support, and two connection rods associated both with corresponding opposite end portions of said rocker arm and also with a respective one of said attachment elements.

12. The apparatus of claim 8, wherein said movement device comprises a pinion pivoted to said support, and two racks engaged with said pinion and attached to a respective one of said attachment elements.

13. The apparatus of claim 5, wherein the apparatus comprises a clamping device operatively connected to said drive means and/or to said actuator when said container is disposed inside said housing compartment.

14. Apparatus The apparatus of claim 1, wherein the apparatus comprises a control unit and detection means which are operatively connected to said control unit and configured to detect a recognition element associated with said bottom wall and to send the detected information to said control unit.

15. A kit for cooking foodstuffs of claim 1 comprising an apparatus, from wherein said kit comprises at least one additional bottom wall distinct from said bottom wall and having a specific surface conformation suitable for different cooking or different foodstuffs to be cooked, and in that said bottom wall is removable and selectively interchangeable with said at least one additional bottom wall. 16. A Kit of claim 15, wherein a control unit of said apparatus, on the basis of the information detected by detection means which cooperate with recognition elements associated with said bottom walls is configured to suggest a cooking mode which can be preferably executed in the container that has the bottom wall detected on each occasion.
